(19) United States
(12) Patent Application Publication
(10) Pub. No.: US 2021/0034238 A1
(43) Pub. Date: Feb. 4, 2021

(54) TRACKING FOR PERSISTENT FLUSH REQUESTS

(71) Applicant: Hewlett Packard Enterprise Development LP, Houston, TX (US)

(72) Inventor: Michael R. Krause, Boulder Creek, CA (US)

(21) Appl. No.: 16/526,927

(22) Filed: Jul. 30, 2019

(51) Int. Cl. G06F 3/06

(52) U.S. Cl. CPC G06F 3/0604; G06F 3/0638; G06F 3/0679

(57) ABSTRACT

A method may include transmitting a request to a responder to modify an addressed resource; tracking the responder in a data structure; receiving a persistent flush command for an address range; and if the address range overlaps addressable resources of the responder, transmitting a persistent flush request packet to the responder.

### BACKGROUND

A memory-semantic interconnect, such as Gen-Z, provides a protocol that enables multiple component types to efficiently communicate. Component types include processors, memory, storage, I/O, FPGA, GPU, GPGPU, DSP, etc. Universal communications simplifies component design and solution composition and may be applicable to multiple solution types including clients (mobility, mobile, desktops/workstations), servers, storage, embedded, and message-based communications.

Some devices on the interconnect may support maintenance of addressable resources in a persistent state, means that resources have reached a processing state such that they are guaranteed to successfully update the underlying media or to be protected against power or hardware failures. In some cases, the addressable resources are not automatically stored in a persistent state, but rather require an explicit command to flush (i.e., write) modified resource to the persistence domain. For example, a flash-backed dynamic random access memory (DRAM) module may require a command to write data stored in DRAM to flash storage media.

### BRIEF DESCRIPTION OF THE DRAWINGS

Certain examples are described in the following detailed description and in reference to the drawings, in which:

FIG. 1 illustrates an example method of tracking responders for targeted persistent flush requests;

FIG. 2 illustrates an example method of tracking responders and address sub-ranges for targeted persistent flush requests;

FIG. 3 illustrates an example data structure which may be used to track modified address sub-ranges;

FIG. 4 illustrates an example set of page table entries that include tracking elements;

FIG. 5 illustrates an example system including a requester device and a plurality of responder devices interconnected using a memory semantic communications protocol; and

FIG. 6 illustrates an example system including a requester device and a plurality of responder devices interconnected using a memory semantic communications protocol.

### DETAILED DESCRIPTION OF SPECIFIC EXAMPLES

Implementations of the disclosed technology provide an architecture to track modified addressable resources on a system with a memory-semantic network. This enables persistent flush commands to be targeted to only those devices and resource ranges that have outstanding modified resources that have not reached a persistent state. This may provide reduced persistent flush execution time as only a subset of resources are flushed by the device. Additionally, if a device with addressable resources is shared by multiple other devices, then this may prevent the persistent flush requests from one device impacting other devices (for example, by avoiding denial-of or reduction-of-service attacks).

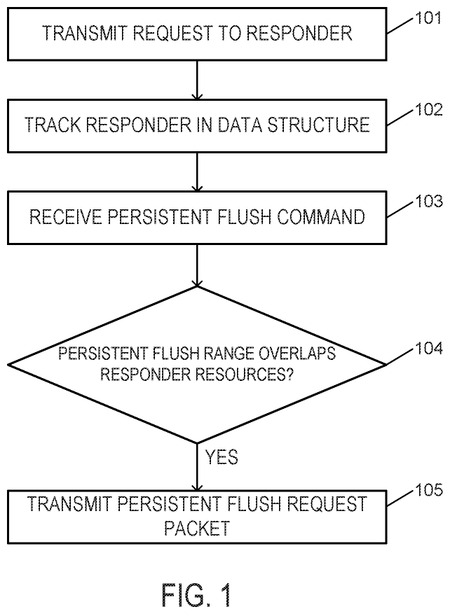

FIG. 1 illustrates an example method of tracking responders for targeted persistent flush requests. For example, the method may be performed by a node on a memory-semantic network. For example, a node may be a device and include a processor or system on a chip (SOC) having an integrated memory or storage controller, a memory module such as a dynamic random access memory (DRAM), non-volatile memory (NVM), or storage class memory (SCM) module, a graphics card or other accelerator, a network controller, a switch, a digital signal processor, a custom application specific integrated circuit (ASIC) or field programmable gate array (FPGA) or other device that communicates using a memory-semantic communication protocol such as the Gen Z protocol. A node may include requester circuitry (“a requester”), responder circuitry (“a responder”), or both. The requester handles the injection of transaction requests, such as read requests and write requests onto the fabric. The responder handles the injection of transaction responses, such as read responses and write acknowledgements, onto the fabric.

In the memory-semantic network, communications correspond to a load/store processor architecture. Communications between nodes may be performed using requests to specific addresses of addressable resources, for example, at the byte address level. The requests may include requests to modify addressable resources. For example, the requests may include write requests. Such write requests may be used to write data to addressable memory or storage. However, the write requests are not necessarily limited to reading and writing data to byte-addressable memory or storage. For example, an accelerator may expose a range of addresses that may be written to in order to access an accelerator work queue. As another example, requests to modify addressable resource may include atomic operation requests supported by the memory-semantic communications protocol, the requester, and the responder. Various types of atomic operation requests may be supported such as add requests, sum in memory requests, swap requests, compare and swap (CAS) requests, and other atomic requests.

In some implementations, each responder has a data space of addressable resources. A requester includes a memory management unit (MMU) that maps one or more responder data spaces into the requester's local address space. The requester may also map resource addresses associated with advanced operations and services into the requester's local address space (such operations/services may include buffer operations as well as unicast and multicast messages). This local address space may be the component-local address space that the memory controller translates application virtual addresses into. For example, this may occur if the requester is integrated into the device's memory controller. In other implementations, this local address space may be separate from the component-local address space. For example, this may occur if the requester is separate from and coupled to the device's memory controller. In these implementations, the requester translates the component-local addresses into the requester-local address space.

In some implementations, the responder data spaces are partitioned into one or more pages. When an application on the requester component allocates memory, the allocated memory is mapped to one or more requester memory pages, with the requester pages mapped to responder pages. In some implementations, the system may support interleaved memory pages and interleave groups. An interleaved memory page associates multiple responders with the addresses corresponding to a single contiguous page.

The method includes block 101. Block 101 includes transmitting a request to a responder to modify an addressed resource. For example, block 101 may be performed after an application or file system issues a command to write data to a virtual memory address. An MMU may perform address translation to map the virtual memory address to an addressed resource corresponding to a particular responder on the memory semantic network. A requester may then send a write request to write the data to the responder address.

The method includes block 102. Block 102 includes tracking the responder in a data structure. For example, block 102 may include tracking a responder identifier corresponding to the responder a data structure. As the component transmits requests to modify addressable resources to multiple responders, each respective responder identifier may be tracked in the data structure. In some cases, block 102 includes tracking the interleave group in the data structure if the responder is a part of an interleave group and the addressable resource is part of an interleaved set of addresses. For example, block 102 may comprise tracking the responder in the data structure in response to receiving a completion packet to the request transmitted in block 101, where the completion packet indicates that the request executed successfully. As another example, block 102 may comprise tracking the responder in the data structure prior to receiving a completion packet. For example, block 102 may be performed upon retrieval of a page table entry.

The method further includes block 103. Block 103 includes receiving a persistent flush command for an address range. For example, the persistent flush command may be a command utilized by the application or file system to ensure that modified data has been flushed to the persistence domain (i.e., that, after the execution of the command, the data is stored in non-volatile media or in volatile media that will be automatically stored in non-volatile media on power failure or other failure condition). As another example, the persistent flush command may be generated by the requester component upon an error condition such as an imminent power failure.

In some implementations, the address range may be a range of virtual address that require translation to a range of addressable resources on the memory-semantic network. In other implementations, the address range may be a range of addresses of addressable resources. In various implementations, the range may be provided as a base address plus an offset, as a set of addresses, or as a starting address and an ending address.

The method further includes block 104. Block 104 comprises determining if the address range overlaps addressable resources of the responder. For example, block 104 may comprise performing address translation to identify one or more responders having addressable resources corresponding to the persistent flush address range. Block 104 may further comprise comparing the responder(s) identified during this translation with the responders tracked in the data structure. If the responder identified during the translation matches a responder tracked in the data structure, then the address range overlaps addressable resources of the responder.

The method further includes block 105. Block 105 is performed if the address range of the persistent flush command overlaps addressable resources of the responder tracked in the data structure. Block 105 comprises transmitting a persistent flush request packet to the responder. The persistent flush request packet has a format as defined by the communications protocol used in the memory semantic network and causes the responder to ensure that any data that is currently in a non-volatile state is moved into its persistent storage (e.g., copied to a non-volatile medium or placed into a battery or capacitor backed location where non-volatile storage occurs automatically at power failure).

If the persistent flush command received in block 103 is addressed to an interleave group, then block 104 includes identifying the interleave group to which the command corresponds. In this case, block 104 further comprises determining if the interleave group is tracked in the data structure. If so, then the address range of the persistent flush command overlaps addressable resources of the responder tracked in the data structure. Accordingly, block 105 is performed and a persistent flush request is transmitted to each member of the interleave group.

The data structure tracks responders with outstanding non-persisted addressable resources. Accordingly, if the responder is not tracked in the data structure (i.e., if block 104 determines that the persistent flush range does not overlap any tracked responder resources), then executing a persistent flush is unnecessary and block 105 is not performed.

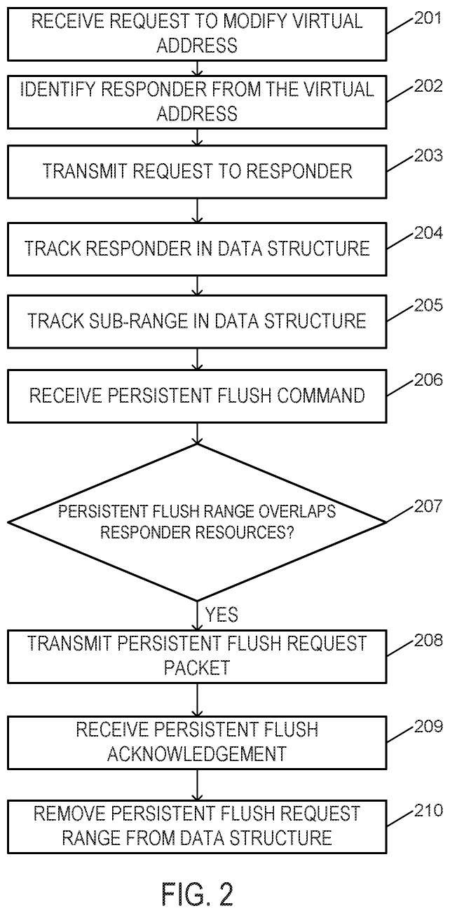

FIG. 2 illustrates an example method of tracking responders and address sub-ranges for targeted persistent flush requests. For example, the method of FIG. 2 may be performed as an implementation of the method of FIG. 1.

The method includes block 201. Block 201 comprises receiving a request to modify a virtual address. For example, the request may be received based on an application issuing a write or other request to modify one of its virtual addresses. As another example, the request may be received from a file system or other program executed by a processor or SoC.

The method includes block 202. Block 202 comprises identifying a responder from the virtual address using a memory management unit (MMU). For example, the memory management unit may be a requester MMU that translates the virtual address into a requester local address that identifies a responder (or interleave group) and an address on the responder for an addressable resource. As another example, the MMU may be a requester MMU that receives a component local address from a preceding component-level MMU. In this example, the requester MMU may identify the responder during translation of the component local address to the requester local address.

The method further includes block 203. Block 203 comprises transmitting a request to the responder identified in block 202 to modify the addressed resource at the responder address corresponding to the virtual address received in block 201. For example, block 203 may be performed as described with respect to block 101 of FIG. 1.

The method further includes block 204. Block 204 comprises tracking the responder in a data structure. For example, block 204 may be performed as 102 of FIG. 1. The method also includes block 205. Block 205 comprises tracking a sub-range of addresses encompassing the address of the modified addressed resource in the data structure. For example, blocks 204 and 205 may be performed after receiving a completion response to the request transmitted in block 203.

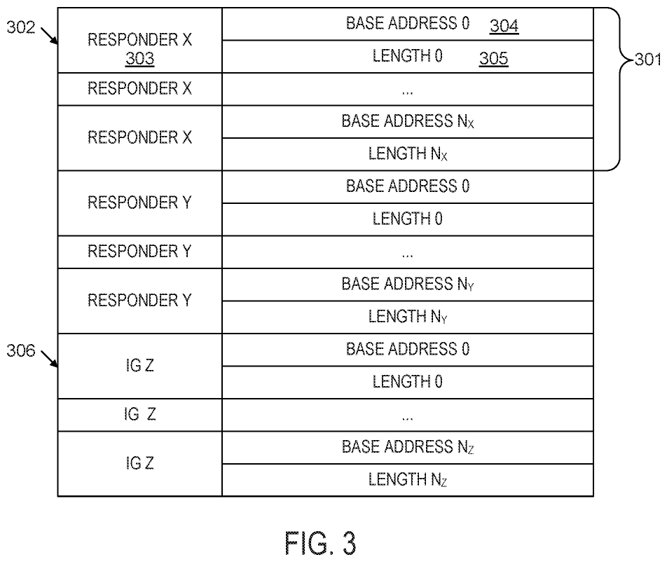

FIG. 3 illustrates an example data structure which may be used to track modified address sub-ranges. In this example, each table entry 302 includes a responder identifier (ID) 303, a base address 304 and a range length 305 (e.g., an offset from the base address 304). In other examples, the tracked sub-range may be defined by a base address and an ending address, a page identifier, or other manner of defining a tracked address range. The number of entries in the table for each responder may vary according to how many outstanding modified resources the responder currently has.

Returning to block 204, block 204 may comprise expanding the address sub-range covered by an entry 302 of the table or adding a new entry to the data structure to track a new address sub-range. For example, block 204 may comprise increasing the length offset 305 of the entry 302 having the greatest base address 304 that is less than the address to be added to the table. As another example, block 204 may comprise decreasing the base address 304 of the nearest entry 302 to the address to be added.

In some implementations, there is a maximum sub-range length that is tracked in the table. In these implementations, if expanding nearest sub-range currently tracked for the responder would extend that sub-range past the maximal length, then a new entry for the responder is added to the table. For example, the maximum sub-range length may correspond to a configurable number of page sizes. For example, the maximum sub-range may be the length of one or more pages. In some cases, the maximum sub-range size may vary by responder. For example, during initialization, a maximum sub-range size for the responder may be configured when responder addressable resources are mapped to the requester local address space.

In some cases, the maximal sub-ranges are page aligned. In these examples, the base address 304 of an entry 302 and end address of the sub-range defined by the length 305 will be on the same page. In other words, a maximal sub-range for an entry 302 for a responder X 303 will coincide with a page allocated for the responder X 303.

As discussed above, in some cases, a responder may be part of an interleave group. In these cases, the interleave group may be tracked in the data structure. For example, in FIG. 3, the entry 306 corresponds to a sub-range tracked for interleave group (IG) Z.

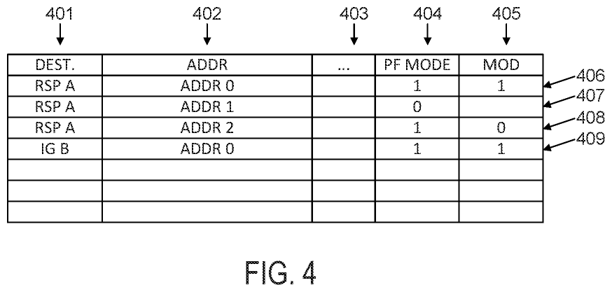

In some implementations, the tracked sub-ranges have page granularities. In these implementations, the tracking structure may be integrated into the requester's page table entries (PTEs). FIG. 4 illustrates an example set of PTEs that include tracking elements. In this example, a PTE 406-409 comprises a plurality of information elements. Here, the PTE includes destination information 401. For example, the destination information 401 identifies the responder or interleave group and may include one or more fields including the responder's address information, such as local address on a local subnet and a global address on the network. The PTE further includes address information 402 which provides a base address on the responder for the page. The PTE further includes a plurality of other fields 403 that provide various information about the page or enable various functionality. For example, the additional fields 403 might include access keys, fields defining whether the page is a data space page or a control space page, traffic class fields, and cache coherence fields.

The PTEs further include persistent flush-related fields 404 & 405. For example, the fields may include a write mode field 404. The write mode field 404 may control various aspects regarding how a write request is translated into a respective request packet as well as the associated semantics, including whether the responder identified in the page, as well as the page itself, should be included in a subsequent distribution of a persistent flush request. The fields 405 & 405 may further include a field 405 indicating whether there is any modified addressable resource in the page.

For example, in the four illustrated PTEs, Responder A has three PTEs 406-408. PTE 406 indicates that the page starting at ADDR 0 is enabled for persistent flush tracking and that data on the page has been modified (i.e., there has been a previous request to modify responder data but that the modified resource has not been incorporated into the responder's persistence domain). PTE 407 has a field 404 that indicates responder and page modification tracking should not occur for the page starting at ADDR 1. PTE 408 has a field 404 that indicates page flush tracking should occur and has a field 405 that indicates that there is not an outstanding modification to an addressable resource. Interleave Group B has a single page table entry 409 with persistent flush tracking enabled in field 404 and an indicator that an addressable resource within the page starting at ADDR 0 of IG B has been modified.

Returning to FIG. 2, in some implementations, blocks 204 and 205 of the method may be performed in parallel with block 203. For example, the requester can update the tracking structure in parallel to the request process when accessing a page table entry or mapping table to locate the responder and corresponding responder-specific address range.

The method further includes block 206. In block 206, the requester receives a persistent flush command. For example, the command may be received upon an application, operating system, or file system issues a persistent flush for a specified range. For example, block 206 may be performed as discussed with respect to block 103 of FIG. 1.

The method further includes block 207. Block 207 comprises determining if the persistent flush command overlaps any of the address sub-ranges tracked in the data structure. For example, block 207 may comprise performing address translation to identify one or more responders having addressable resources corresponding to the persistent flush address range. Block 207 may further comprise comparing the responder(s) identified during this translation with the responders tracked in the data structure. If the responder identified during the translation matches a responder tracked in the data structure, then the remainder of the address is compared to the tracked address, length pairs 304, 305 for the identified responder to determine if the persistent flush command address range includes any outstanding non-persisted data.

If so, then the method proceeds to block 208. Block 208 comprises transmitting persistent flush request packets to the responders identified in block 207. The persistent flush request packets may include an identification of the sub-range that the responder should persist. For example, the persistent flush request may include the intersection of the address range from the persistent flush command and an entry from the data structure tracking the sub-ranges. Alternatively, the persistent flush request may include the entire sub-range tracked by an entry in the data structure if the persistent flush command's range overlaps that entry's sub range.

In some cases, if the persistent flush command range intersects more than one entry of the table, then a separate flush request is sent for each entry of the table (with each flush request including the intersection of the sub-range of the corresponding entry with the persistent flush command range). In other cases, the persistent flush request may include a range larger than the intersection of the persistent flush command range and an entry of the table. For example, if each data structure entry tracks a page that has any modified data, and the persistent flush command includes addresses from a tracked page, then a persistent flush request for the entire page may be sent.

The method further includes block 209. Block 209 comprises receiving an acknowledgement to a persistent flush request packet transmitted in block 208. For example, the acknowledgement may be a positive acknowledgement from a responder indicating that the responder received the persistent flush request packet and executed the persistent flush on the resources addressed by the packet.

The method also includes block 210. In block 210, in response to the persistent flush acknowledgement, the requester removes the sub-range included in the acknowledged persistent request packet from the data structure. For example, block 210 may comprise removing an entry from a table. As another example, block 210 may comprise reducing the size of a tracked sub-range in response to a portion of the sub-range being persisted.

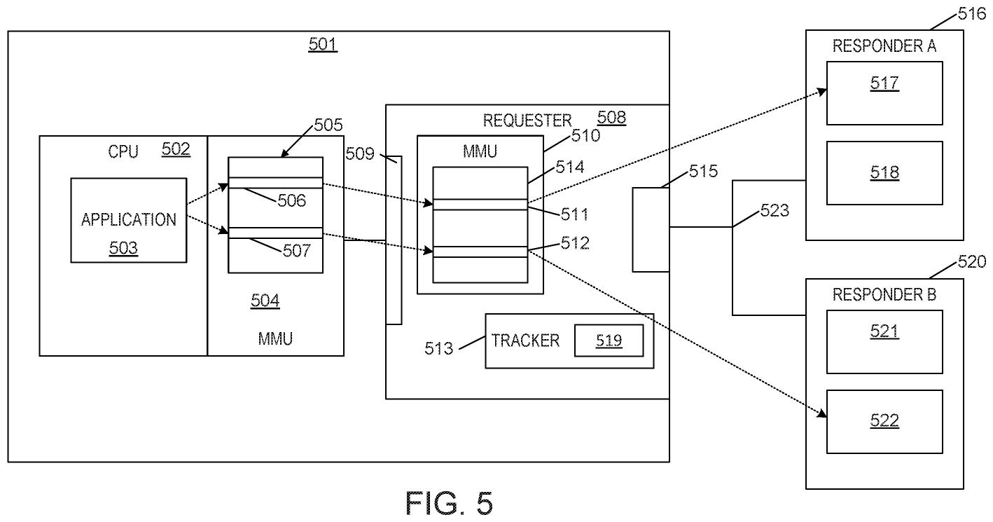

FIG. 5 illustrates an example system including a requester device and a plurality of responder devices interconnected using a memory semantic communications protocol.

The device 501 includes a requester device 508. For example, the requester device 508 may be implemented as an application specific integrated circuit (ASIC), as a controller executing firmware stored on a non-transitory computer readable medium, or a combination thereof. In this example, the device 501 further comprises an SoC including a CPU 502 and integrated local MMU 504 and an interface 509 to the local MMU 504. However, as discussed above, in other examples, the component local 504 MMU may not be present and the requester 508 may be integrated into the SoC, with interface 509 being an on-chip interface to the CPU 502. In still further examples, the device 501 may be a GPU, accelerator, or other device that may modify responder resources without a CPU 502.

The requester 508 is allocated one or more partitions 517, 518, 521, 522 of addressable resources from a plurality of responders 516, 520. In this example, the requester 508 is allocated partition 517 from responder A 516 and partition 522 from responder B 520. For example, the partitions may be page-sized ranges of addressable resources, such as memory addresses.

The requester 508 includes an MMU 510 which includes a page mapping data structure such as a page table 514 or page grid. The requester 508 uses MMU 510 including the page table 514 to associate a first local address range 511 with the first partition 517 and a second local address range 512 with the second partition 522. For example, the association may be performed using page table entries 511, 512. In this example, the local address range is a requester-local address range 508 and the device 501 further comprises a component-local address range maintained by the SoC integrated MMU 504 using page table 505. Here, an application's 503 virtual address space is mapped into the component local address space using MMU 504 and the component local address space is mapped into the requester local address space using page table 514. For example, page 506 is mapped to page 511, which is mapped to partition 517. In other examples, the MMU 504 is not present, and application 503 virtual addresses are mapped directly into the single local address space using MMU 510.

The requester 508 further comprises a tracker 513. The tracker 513 may comprise a hardware component or software stored on a non-transitory computer readable medium and executed by a processor, or a combination thereof. The tracker is to track responders in a data structure 519 that have outstanding modified addressable resources that have not yet been persisted. For example, the data structure may be as described with respect to FIG. 1 or FIGS. 2 and 3.

In some implementations, the tracker 513 tracks only those responders which have outstanding modified addressable resources which have not been flushed (i.e., written back) to persistent media. For example, the requester 508 may include an interface 515 to the network 523. When the requester 508 transmits a request to a responder 516 to modify an addressed resource and receives a successful completion response, such as an cacheline-sized chunk of data starting at a byte address within partition 516, the tracker 513 updates the data structure to add the responder (if the responder ID is not already present in the data structure). For example, if the application 503 issues a write to an address within page 507, the tracker 513 tracks responder B's ID in its data structure 519; if the application 503 issues a write to an address with page 506, the tracker tracks responder A's ID in the data structure 519.

In these implementations, when a persistent flush command is issued by the component 501 (for example, by application 503), the requester 508 translates the address range within the command to determine which responder or responders are targeted by the command. The requester 508 then uses the tracker to determine if a targeted responder is present in the data structure 519. If so, then a persistent flush request is issued to that responder. If not, then a persistent flush request is not sent because that responder does not have any modified, non-persisted addressable resources that fall within the range of the flush command.

In some implementations, the tracker 513 also tracks address sub-ranges that encompass modified addressable resources that have not been flushed to persistent media. For example, when receiving a request to modify an addressable resource from the CPU 502, the tracker 513 may expand a tracked address sub-range to encompass the new address, create a new entry in the tracking data structure to encompass the new address, as described with respect to FIGS. 2 and 3.

In these implementations, when a persistent flush command is received by the requester 508, the requester translates the range within the received command to its requester local address range and determines if that range overlaps with any address sub-ranges tracked in the data structure 519. The requester 508 then generates and transmits persistent flush requests for any tracked sub-ranges that overlap with the persistent flush command range. Once the requester 508 receives completion responses to the persistent flush requests, it removes the corresponding sub-ranges from the data structure 519.

In various implementations, different responders 516, 520 may have different capabilities to flush resources to persistence. For example, some responders may be able to flush any range of addressable resources to the persistent domain, some responders may be able to flush page-sized ranges of data at a time, while other responders may only be able to flush their entire addressable set of resources to persistence. Accordingly, different responders may respond to received persistent flush commands differently. For example, if a responder supports arbitrary range flushes, it may flush only the range contained within the persistent flush request. If it supports page-based flushes, it flushes the entire page encompassing the sub-range contained within the persistent flush request. If it supports only complete flushes, then it flushes its entire address space in response to the persistent flush command.

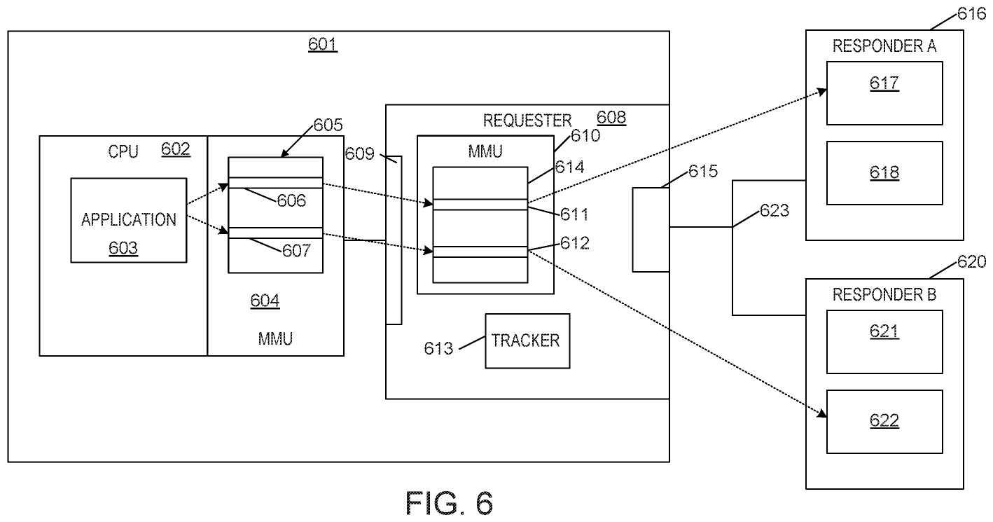

FIG. 6 illustrates an example system including a requester device and a plurality of responder devices interconnected using a memory semantic communications protocol. The device 601 includes a requester device 608. For example, the requester device 608 may be implemented as an application specific integrated circuit (ASIC), as a controller executing firmware stored on a non-transitory computer readable medium, or a combination thereof. In this example, the device 601 further comprises a SoC including a CPU 602 and integrated local MMU 604 and an interface 609 to the local MMU 604. However, as discussed above, in other examples, the component local 604 MMU may not be present and the requester 608 may be integrated into the SoC, with interface 609 being an on-chip interface to the CPU 602. In still further examples, the device 601 may be a GPU, accelerator, or other device that may modify responder resources without a CPU 602.

The requester 608 is allocated one or more partitions 617, 618, 621, 622 of addressable resources from a plurality of responders 616, 620. In this example, the requester 608 is allocated partition 617 from responder A 616 and partition 622 from responder B 620. For example, the partitions may be page-sized ranges of addressable resources, such as memory addresses.

The requester 608 includes an MMU 610 which includes a page mapping data structure such as a page table 614 or page grid. The requester 608 uses MMU 610 including the page table 614 to associate a first local address range 611 with the first partition 617 and a second local address range 612 with the second partition 622. For example, the association may be performed using page table entries 611, 612. In this example, the local address range is a requester-local address range 608 and the device 601 further comprises a component-local address range maintained by the SoC integrated MMU 604 using page table 605. Here, an application's 603 virtual address space is mapped into the component local address space using MMU 604 and the component local address space is mapped into the requester local address space using page table 614. For example, page 606 is mapped to page 611, which is mapped to partition 617. In other examples, the MMU 604 is not present, and application 603 virtual addresses are mapped directly into the single local address space using MMU 610.

The requester 608 further comprises a tracker 613. The tracker 613 may comprise a hardware component or software stored on a non-transitory computer readable medium and executed by a processor, or a combination thereof. The tracker 613 tracks modified pages in their respective PTEs 611, 612, as described with respect to FIGS. 2 and 4. In some implementations, the tracker 613 component may be integrated with the MMU 610 as a single component.

In some implementations, the tracker 613 tracks only those responders which have outstanding modified addressable resources which have not been flushed (i.e., written back) to persistent media. For example, the requester 608 may include an interface 615 to the network 623. When the requester 608 transmits a request to a responder 616 to modify an addressed resource and receives a successful completion response, the tracker 613 updates the page table for the corresponding page to indicate that the page includes a modified resource. For example, if the application 603 issues a write to an address within page 607, the tracker 613 updates the tracking information element in PTE 612; if the application 603 issues a write to an address with page 606, the tracker updates the tracking information element in PTE 611. In some implementations, the tracker 613 updates the relevant PTE 611, 612 during the PTE lookup procedure performed by the MMU 610. For example, an integrated tracker 613/MMU 610 may update the PTE 611, 612 immediately upon retrieving the PTE. In other implementations, the tracker 613 updates the PTE after receiving a successful completion packet from the corresponding responder.

In these implementations, when a persistent flush command is issued by the component 601 (for example, by application 603), the requester 608 translates the address range within the command to determine which pages are targeted by the command. The requester 608 then uses the PTEs for those pages to determine if they should be subject to a persistent flush request. For example, as described with respect to FIG. 4, the requester 608 may determine which targeted pages have a persistent flush request mode active and which of those active pages have modified data. Persistent flush request packets are then sent for only those pages that are in active mode and have modified data. For targeted pages not meeting these conditions, no persistent flush request packet is necessary.

In In various implementations, different responders 616, 620 may have different capabilities to flush resources to persistence. For example, some responders may be able to flush any range of addressable resources to the persistent domain, some responders may be able to flush page-sized ranges of data at a time, while other responders may only be able to flush their entire addressable set of resources to persistence. Accordingly, different responders may respond to received persistent flush commands differently. For example, if a responder supports arbitrary range flushes, it may flush only the range contained within the persistent flush request. If it supports page-based flushes, it flushes the entire page encompassing the sub-range contained within the persistent flush request. If it supports only complete flushes, then it flushes its entire address space in response to the persistent flush command.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method, comprising:
transmitting a request to a responder to modify an addressed resource;
tracking the responder in a data structure;
receiving a persistent flush command for an address range; and
if the address range overlaps addressable resources of the responder,
transmitting a persistent flush request packet to the responder.

2. The method of claim 1, wherein:
the responder is a member of an interleave group; and
tracking the responder in the data structure comprises tracking the interleave group in the data structure.

3. The method of claim 2, further comprising:
transmitting a corresponding persistent flush request packet to each member of the interleave group.

4. The method of claim 1, further comprising:
removing the responder from the data structure after receiving an acknowledgement of the persistent flush request packet.

5. The method of claim 1, further comprising:
tracking the responder and a sub-range of addresses encompassing the address of the modified addressed resource in the data structure; and
generating the persistent flush request packet if the address range overlaps with the sub-range of addresses;
wherein the persistent flush request includes an identification of the sub-range.

6. The method of claim 5, further comprising:
tracking a plurality of sub-ranges within the data structure, each particular sub-range having a maximum size equal to a memory partition size of a responder or memory interleave group corresponding to the particular sub-range.

7. The method of claim 5, wherein the data structure comprises a page table entry and tracking the sub-range of addresses comprises updating a page table entry field to indicate that a page described by the page table entry includes a modified addressable resource.

8. The method of claim 1, further comprising:
receiving a request to modify a virtual address;
translating the virtual address to a requester local address;
determining a page address from a page table entry using the requester local address; and
updating the page table entry to indicate that the page includes a modified addressable resource that has not been committed to persistence.

9. A device, comprising:
a requester to transmit a request to a responder to modify an addressed resource;
a tracker to track the responder in a data structure; and
an interface to a local component to receive a persistent flush command for an address range; wherein
the requester is to generate and transmit a persistent flush request packet for the responder if the address range overlaps addressable resources of the responder.

10. The device of claim 8, wherein the tracker is to:
track an address sub-range associated with the responder that encompasses previously modified addressable resources of the responder; and
update the tracked address sub-range to encompass the addressed resource modified by the request if the address range overlaps with a maximal size of the address sub-range.

11. The device of claim 9, wherein the tracker is to:
track a second address sub-range associated with the responder that encompasses previously modified addressable resources of the responder outside of the maximal size of the address sub-range; and
update the second tracked address sub-range to encompass the addressable resource modified by the request if the address range overlaps with the maximal size of the second address sub-range.

12. The device of claim 10, wherein the persistent flush request packet includes the address sub-range overlapping the address range.

13. The device of claim 11, wherein the tracker is to remove the address sub-range transmitted in the persistent flush range from the data structure after receiving a completion response to the persistent flush response from the responder.

14. The device of claim 9, wherein the data structure comprises a page table entry, the page table entry including a responder identifier and information indicating whether the corresponding page includes a modified addressable resource that has not been committed to persistence.

15. The device of claim 10, wherein the persistent flush request includes a base address of the corresponding page.

16. The device of claim 11, wherein the first address sub-range is associated with an interleave group and the responder is a member of the interleave group.

17. A system, comprising:
a requester allocated a first addressable resource partition of a first responder and allocated a second addressable resource partition of a second responder, the requester comprising:
a memory management unit to:
associate a first local address range with the first addressable resource partition and a second local address range with the second addressable resource partition; and
translate a received local address into a resource address, the resource address falling within the first partition or within the second partition; and
a tracker to track the first responder in a data structure if the resource address falls within the first partition and to track the second responder in the data structure if the resource falls within the second partition; and wherein the requester is to:
transmit a request to modify a resource addressed by the resource address;
receive a persistent flush command;
use the tracker to identify the first responder or the second responder as having a modified resource; and
generate a persistent flush request for the identified responder.

18. The system of claim 15, wherein:
the tracker is to track a first sub-range of modified resource addresses associated with the first responder and a second sub-range of modified resource addresses associated with the second responder; and
in response to the persistent flush command, the requester is to:
use the tracker to identify the first sub-range associated with the first responder and identify the second sub-range associated with the second responder;
transmit a first persistent flush request for the first sub-range to the first responder; and
transmit a second persistent flush request for the second sub-range to the second responder.

19. The system of claim 16, further comprising the first responder to:
receive the first persistent flush request; and
in response to receiving the first persistent flush request, flushing all addressable resources.

20. The system of claim 16, further comprising the first responder to:
receive the first persistent flush request; and
in response to receiving the first persistent flush request, flushing only the addressable resources of the first sub-range.
